(19) United States
(12) Patent Application Publication
(10) Pub. No.: US 2010/0161215 A1
(43) Pub. Date: Jun. 24, 2010

(54) Point of interest (POI) navigation search using business hours

(76) Inventor: Vijay Karani, Fremont, CA (US)

Correspondence Address: MANELLI DENISON & SELTER PLLC;7th Floor, 2000 M Street, N.W., Washington, DC, 20036-3307, US

(21) Appl. No.: 12/654,469

(22) Filed: Dec. 22, 2009

Related U.S. Application Data
(60) Provisional application No. 61/193,806, filed on Dec. 24, 2008.

(51) Int. Cl. G01C 21/36; H04M 1/00

(52) U.S. Cl. 701/204; 455/556.1

(57) ABSTRACT

Point of interest (POI) navigation uses search results displayed based both on the current time of day, as well as matching business hours of operation of the displayed POI. In this way, as desired by appropriate menu selection, only businesses that are currently open (or open at an estimated time of arrival (TOA)) are displayed as relevant POIs. The mobile device navigation system considers an approximate time of arrival (TOA) to each relevant POI, and determines whether each POI is open or otherwise usable by the user of the device. The mobile device navigation system may display a POI result identifying the farthest POI meeting given criteria that would be open at the estimated time of arrival, along a preplanned route, or within range of the onboard fuel.

The present invention claims priority from U.S. Provisional Application 61/193,806, filed Dec. 24, 2008, entitled “POINT OF INTEREST (poi) NAVIGATION SEARCH USING BUSINESS HOURS”, to KARANI, the entirety of which is expressly incorporated herein by reference.

### BACKGROUND OF THE INVENTION

1. Field of the Invention

This invention relates generally to navigation systems. More particularly, it relates to wireless navigation systems including point of interest (POI) capabilities.

2. Background of the Related Art

Points of Interest, commonly abbreviated POIs, are a well known concept in Geographic systems. A Point of Interest is defined for purposes of this invention as an object associated with a latitude and longitude, for some period of time, the location of which at least one person would reasonably be expected to have an interest.

Current location aware wireless applications, and navigation devices provide the locations of many types of objects. Location aware devices such as wireless applications, and navigation devices, henceforth referred to as smart navigation application. This includes Point of Interest (POI) information for consumers including places of business, tourist destinations, government buildings and similar objects. In addition some applications provide locations of people of interest such as family members and friends. Business applications may provide the tracked locations of employees or their vehicles. Other types of information such as traffic and weather are provided in some applications. All of these applications provide the locations of objects from recorded and stored latitude and longitudes.

Currently with navigation systems, particularly smart navigation application systems, a user can search for point-of-interest icons based on user selected criterion. The user may view the resultant point-of-interest as an icon on a map where the location of an icon is representative of the location (street address) of the corresponding point-of-interest.

FIG. 7 shows conventional points-of-interest having fixed locations.

In particular, as shown in FIG. 7, several points-of-interest 501-503 depict the locations of a given type of point-of-interest, e.g., fast food restaurants.

Navigation systems provide a user at any time with useful direction and navigation information, permitting a smart navigation application user, the ability not only to locate a suitable POI, but also to provide directions to get to any given POI address.

### SUMMARY OF THE INVENTION

In accordance with the principles of the present invention, a method of providing hour-based navigation to a physical navigation device comprises identifying a plurality of physical points-of-interest (POI) based on navigation search criteria. Hour-based information relating to each of the plurality of physical POI is retrieved. A time of estimated time of arrival to the retrieved hour-based information is displayed, together with hour-based information for each of the plurality of physical POI. The plurality of physical POI is filtered to a sub-plurality of physical POI meeting a useable hour-based status.

In accordance with another aspect of the invention, a method of providing hour-based navigation to a physical navigation device comprises identifying a plurality of physical points-of-interest (POI) based on navigation search criteria. Hour-based information relating to each of the plurality of physical POI is retrieved. An estimated time of arrival (TOA) is compared to the retrieved hour-based information for each of the physical plurality of POI to determine a current hour-based status of each of the plurality of physical POI. The plurality of physical POI is filtered to a sub-plurality of physical POI meeting a useable hour-based status.

### BRIEF DESCRIPTION OF THE DRAWINGS

Features and advantages of the present invention will become apparent to those skilled in the art from the following description with reference to the drawings:

FIG. 1 shows an exemplary wireless navigation system including a point of interest (POI) hour-based database, in accordance with the principles of the present invention.

FIG. 2 shows elements required for creation and maintenance of a point of interest (POI) hour-based database accessible by a suitable server machine, and formed with business hour-based point-of-interest information, in accordance with the principles of the present invention.

FIG. 3 shows exemplary (POI) hour-based entries in the POI hour-based database shown in FIGS. 1 and 2.

FIG. 4 depicts a point of interest (POI) search using the POI hour-based mobile device navigation system shown in FIGS. 1 and 2, in accordance with the principles of the present invention, including a POI hour-based search around a given location performed at 2 pm, and around the same given location performed at 11 pm.

FIG. 5A shows a wireless navigation device such as a smartphone displaying the results of a POI hour-based search performed at 4 pm, in accordance with the principles of the present invention.

FIG. 5B shows a wireless navigation device such as a smartphone displaying the results of the same POI hour-based search as shown in FIG. 5A, but this time performed at 10:01 pm, in accordance with the principles of the present invention.

FIG. 5C shows a wireless navigation device such as a smartphone displaying the results of the same POI hour-based search as shown in FIGS. 5A and 5B, but this time performed at 11:15 pm, in accordance with the principles of the present invention.

FIG. 5D shows a wireless navigation device such as a smartphone displaying the results of the same POI hour-based search as shown in FIGS. 5A-5C, but this time performed at 4:00 am, with a configuration radius of within 1 mile, in accordance with the principles of the present invention.

FIG. 5E shows a wireless navigation device such as a smartphone displaying the results of the same POI hour-based search as shown in FIGS. 5A-5C, but this time performed at 4:00 am, and this time with a larger search radius configured of suitable pharmacies within 10 miles, in accordance with the principles of the present invention.

FIG. 5F shows a wireless navigation device such as a smartphone displaying the results of the same POI hour-based search as shown in FIGS. 5A-5C, but this time performed at 4:00 am, configured to show POIs that will be opening at some point in the near future, e.g., within 1 hour, in accordance with the principles of the present invention.

FIG. 6 depicts the physical display of a wireless navigation device such as a smartphone displaying the results of a POI hour-based search, configured to show POIs that will be closing at some point in the near future, e.g., within 30 minutes, as well as POIs within the search criteria that will have an hour-based feature occurring within the near future, e.g., breakfast starting within 30 minutes, in accordance with the principles of the present invention.

FIG. 7 shows conventional points-of-interest having fixed locations.

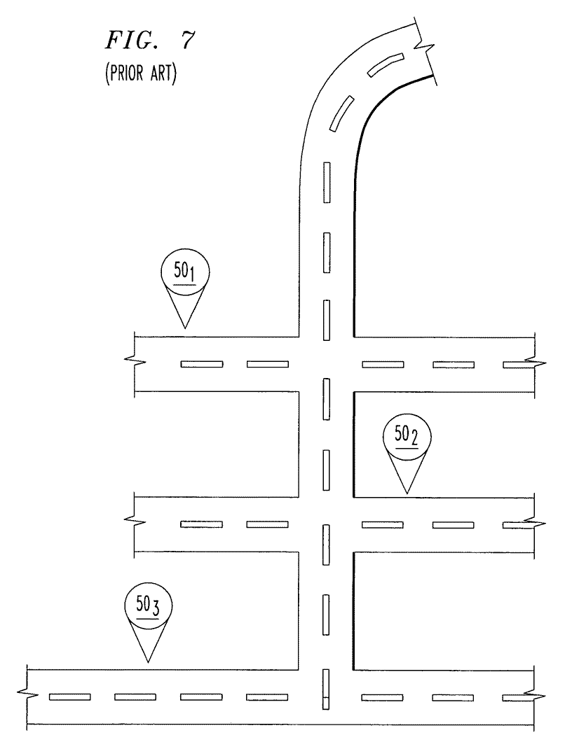

### DETAILED DESCRIPTION OF ILLUSTRATIVE EMBODIMENTS

Conventional smart navigation applications includes mapping, navigator, and POI applications present all searched points of interest (POI) within a given vicinity, for use in navigation of a vehicle to such POIs. But the inventor of the present invention has realized that conventional navigation systems display POIs which meet a given geographic and/or type criteria, and navigation is guided to a selected POI. At best, existing mobile navigation systems present POIs, with an address of the POI.

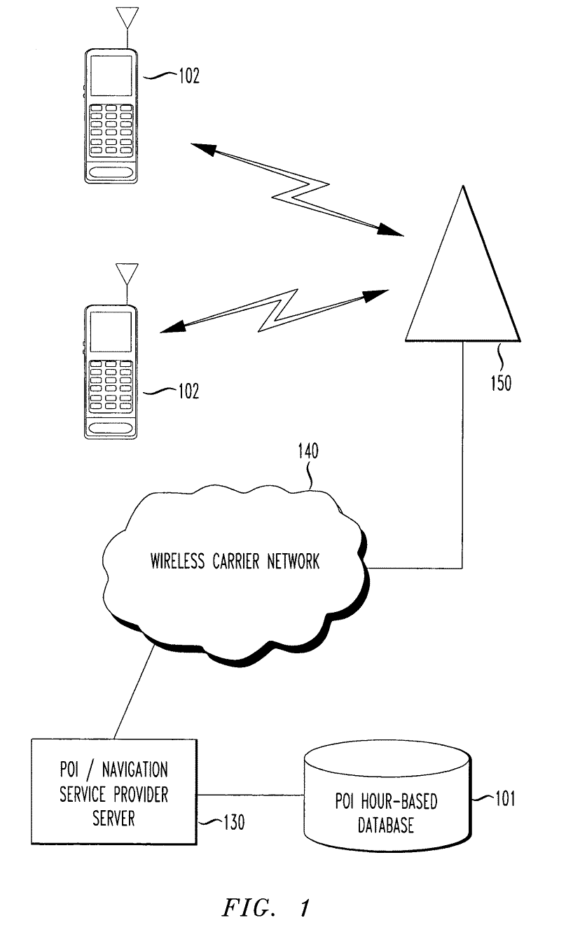

FIG. 1 shows an exemplary wireless navigation system including a point of interest (POI) hour-based database, in accordance with the principles of the present invention.

In particular, as shown in FIG. 1, mobile devices 102 controlled by respective navigation programs capable of POI search are serviced in a wireless carrier network 140 via an appropriate base station 150. In accordance with the principles of the present invention, an appropriate POI/navigation service provider server 130 supports dynamic POI search using an appropriate POI hour-based database 101.

As the inventor of the present inventor has realized, otherwise conventional mobile devices may, at times, guide the user to a POI at a time at which the POI is inaccessible for the intended purpose, e.g., it may be closed. Such navigation is wasteful and bad for the environment. The present invention provides a mobile device 102 including a navigation system with access to a POI hour-based database 101 built to include time of day (TOD) information for given POIs. Exemplary TOD information includes hours of operation, days of week of operation, hours for given services (e.g., breakfast served, dinner served).

The mobile devices 102 controlled to serve as navigation systems have access to the POI hour-based database 101 via an appropriate wireless service, e.g., via a wireless phone network, WiFi, 2G wireless, 3G wireless, 4G wireless, Wi-Max, LTE, etc. The mobile device navigation system 102 compares hour-based POI results against estimated time of arrival (TOA) to each of the relevant POIs, and the day of the week of the TOA.

Thus the mobile device navigation system 102 preferably considers an approximate time of arrival (TOA) from their current location to each relevant POI, and determines whether or not each POI is open or otherwise usable by the user of the device. The use of TOA is important to best avoid wasteful navigation by the mobile device navigation system 102 to a POI just after it closes, or stops serving breakfast, etc.

For instance, the time of day that the mobile device navigation system 102 is estimated to be capable of arriving at is calculated (presuming a given mode of travel such as walking, driving, etc.; and presuming assumed travel speed via the found best path.) The calculated time of arrival (TOA) is compared by the mobile device navigation system 102 against hour-based information obtained from the POI hour-based database 101 for each relevant POI meeting given search criteria.

For example, operational hours of a given business or store are received by the mobile device navigation system 102 from the POI hour-based database 101, and the navigation device 102 makes an automated decision about whether or not the relevant POI should be included or excluded in the POI results displayed on the display of the smart navigation application 102.

Thus, the present invention provides point of interest (POI) navigation using search results displayed based both on the current time of day, as well as matching business hours of operation of the displayed POI. In this way, as desired by appropriate menu selection, only businesses that are currently open (or open at an estimated time of arrival (TOA)) are displayed as relevant POIs.

In yet another embodiment, the smart navigation application system 102 may present POI as a result of a search, with a displayed TIME at which the smart navigation application system 102 would be able to arrive at the relevant POI. In a preferred embodiment, the TIME at which the smart navigation application system 102 would arrive at the relevant POI would be displayed together with a display of hour-based information for that POI. This way a user may be able to determine if the estimated time of arrival (TOA) would make such a POI useful. This would be particularly useful for POIs that are a distance away.

In yet another embodiment, the smart navigation application system 102 includes indication of current traffic and(or) weather conditions, and includes such current traffic and(or) weather and(or) other source conditions that affect TOA when calculating estimated TOA for each POI. In this embodiment, the TIME at which the mobile device navigation system 102 would arrive at the relevant POI becomes extremely helpful.

In another embodiment, the mobile device navigation system 102 displays a POI result identifying the farthest POI meeting given criteria from their current location or input starting point (e.g., the farthest gas station or farthest pancake house) that would be open at the estimated time of arrival, along a preplanned route, or within range of the onboard fuel. Preferably such criteria is user selectable. In another embodiment the mobile device navigation system 102 permits user configuration to calculate the farthest gas station based on a minimum amount of remaining fuel, e.g., the farthest gas station reachable with 1 gallon of fuel remaining in fuel tank; or in the case of a hybrid vehicle within range of all remaining carbon-based fuel without regard to a remaining amount of battery; or vice versa.

In accordance with the principles of the present invention, the POI hour-based database 101 comprises data collected from POI vendors that have relevant hour-based information. The POI hour-based database 101 may of course include POI information that doesn't have any hour-based information associated therewith, or have benign information attached (e.g., open 24 hours), but importantly the POI hour-based database 101 includes POIs that do include searchable hour-based information.

Preferably the POI hour-based database 101 is dynamically updated to reflect changes in hour-based data, e.g., where store or business hours might change based on the season. Such updates may be periodic or on demand.

Traffic information is preferably accessed via the POI/navigation service provider server 130 shown in FIG. 1. The smart navigation application on the device 102 preferably includes updated traffic, weather information, and includes consideration given to reported traffic, weather problems.

In other embodiments, the estimated time of arrival (TOA) to each relevant POI includes consideration to current traffic, weather information. For instance, if travel to a relevant POI includes travel along a highway currently with a 20 minute backup, the estimated TOA is increased by 20 minutes.

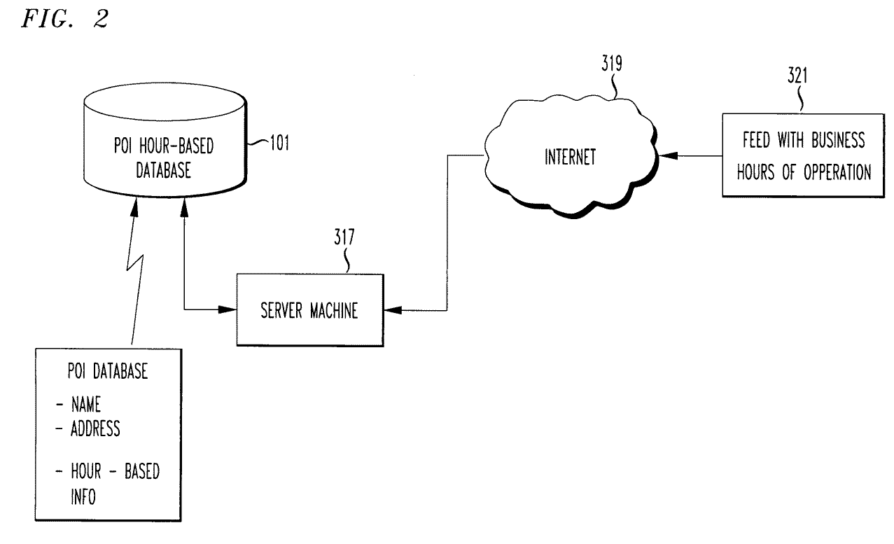

FIG. 2 shows elements required for creation and maintenance of a point of interest (POI) hour-based database accessible by a suitable server machine, and formed with business hour-based point-of-interest information, in accordance with the principles of the present invention.

In a centralized application as shown in FIG. 2, the POI hour-based database 101 may be dynamically revised and updated by relevant POI vendors 321 to reflect day-to-day changes, e.g., as a result of current weather. For instance, heavy rain may close an outdoor barbeque restaurant to close for the day, and the POI hour-based database 101 may be dynamically updated to reflect that closing, thus no longer presenting such a POI to requesting mobile device navigation systems 102 until the business reopens. For such purpose, an update server 317 with access to an Internet 319 and also having access and authority to change data sets within the POI hour-based database 101 may be implemented.

As shown in FIG. 2, point of interest (POI) information is preferably received from the respective POI vendors 321 (or otherwise obtained, e.g., via an suitable server operating an appropriate web crawl) and input as a dynamic feed of business hours of operation or other hour-based information into the POI hour-based database 101.

Hour-based information associated with each POI preferably includes the name of the POI, the street address of the POI, and hour-based information such as hours of operation, hours for breakfast, hours for lunch, etc.

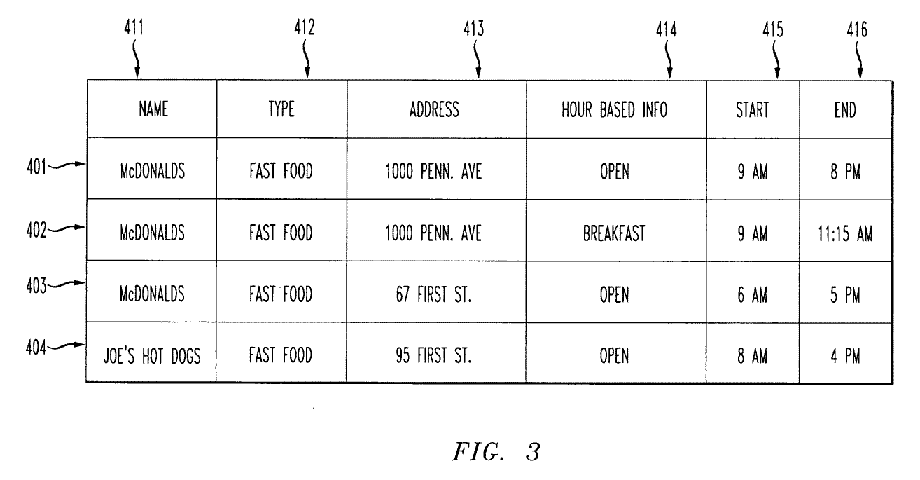

FIG. 3 shows exemplary POI hour-based point of interest (POI) entries in the POI hour-based database 101 shown in FIGS. 1-3.

In particular, FIG. 3 shows four POIs 401-404, each POI 401-404 being associated with other-wise conventional POI information such as name 411, type POI 412, and address 413, but importantly also include hour-based information 414-416.

Exemplary hour-based information 414-416 includes the hour-based activity 414, e.g., “open”, or “breakfast”. Other hour-based information may include a START time 415 for the given hour-based activity 414, e.g., 09:00, 06:00, 08:00, etc. Similarly, the hour-based information preferably includes an END time 416 for the associated hour-based activity 414, e.g., 20:00, 11:15, 17:00, or 16:00.

In preferred embodiments, multiple hour-based information may be associated with a single POI.

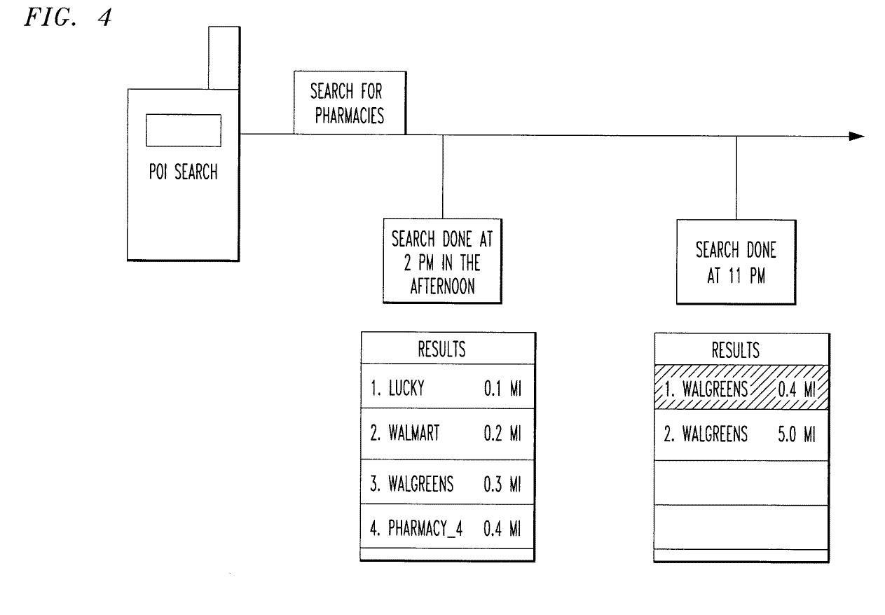

FIG. 4 depicts a point of interest (POI) search using the POI hour-based smart navigation application system 102 shown in FIGS. 1 and 2, in accordance with the principles of the present invention, including a POI hour-based search around a given location performed at 2 pm, and around the same given location performed at 11 pm.

In particular, as shown in FIG. 4, the invention includes two critical components:

(a) business hours or other hour-based information (either static and/or dynamically updated); and

(b) a server search capability to retrieve the business hours or other hour-based information for selected POIs.

In the embodiment of FIG. 4, the smart navigation application system 102 preferably displays hour-based information with color-coding. For instance, the display of the mobile device navigation system 102 preferably presents a series of POIs to the user, allowing selection of a desired POI based on the presented hour-based information.

Preferably the color coding indicates an urgency in time before the current hour-based activity ends, e.g., before the relevant POI closes. In the disclosed embodiment, a given color background such as yellow, or appropriate shading in a monochrome display, may be used to indicate that the displayed POI closes within a given time, e.g. 1 hour, etc. Preferably the given time to close receiving such urgency may be configured by the user of the smart navigation application system 102.

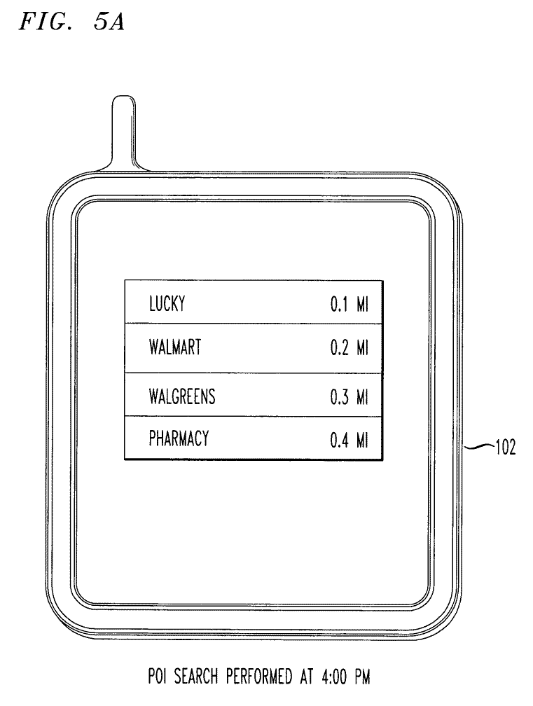

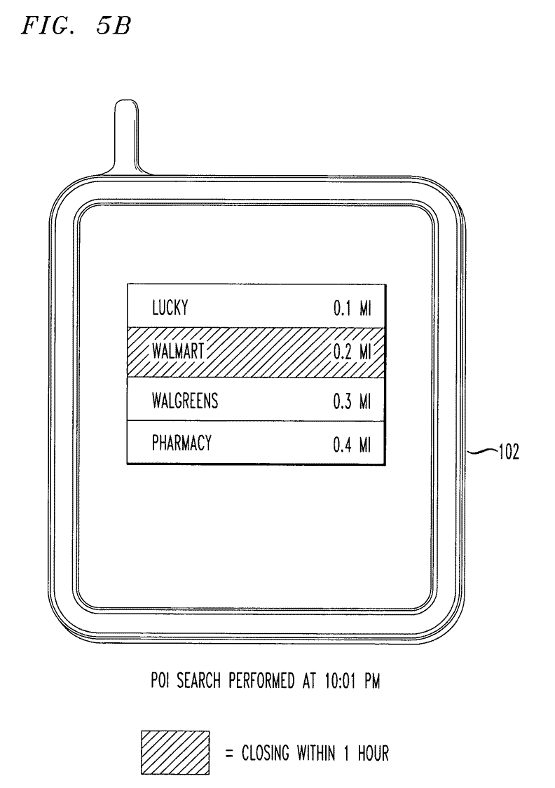

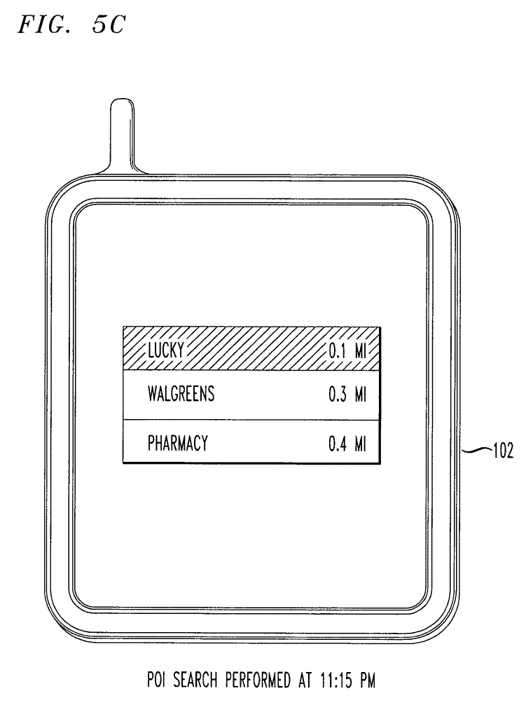

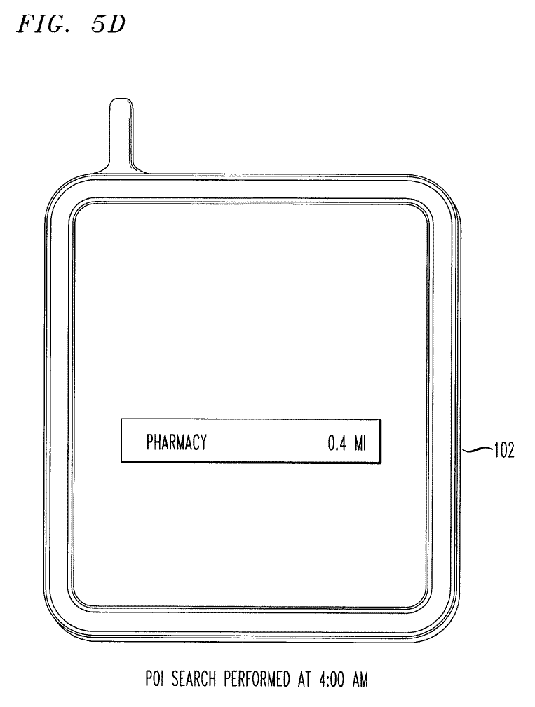

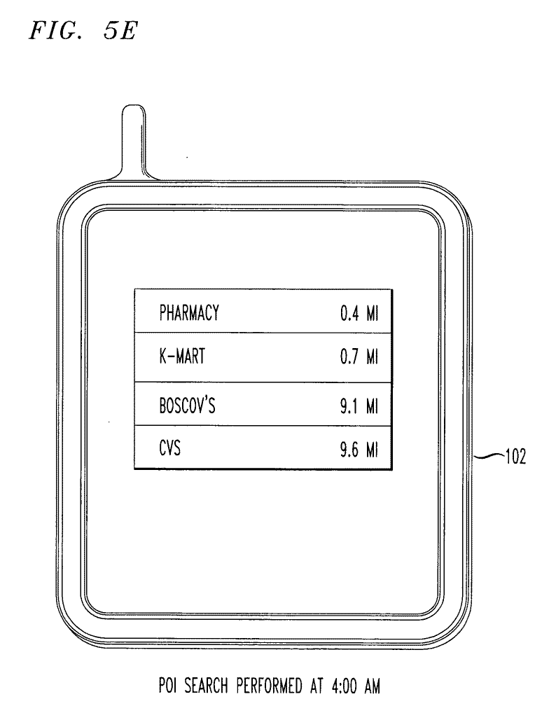

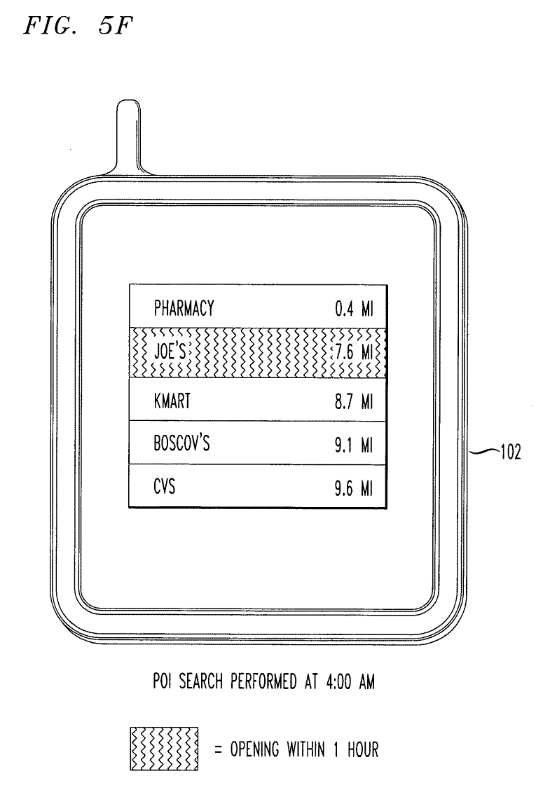

FIG. 5A shows a smart navigation application device 102 such as a smartphone (e.g., iPhone) displaying the results of a POI hour-based search performed at 4 pm (16:00), in accordance with the principles of the present invention.

In particular, as shown in FIG. 5A, as a result of the POI hour-based search performed at 4 pm for pharmacies (as depicted in FIG. 4), the mobile device navigation device 102 displays that a store called LUCKY is 0.1 miles away from the current location, WALMART is 0.2 miles away, WALGREENS is 0.3 miles away, and a PHARMACY is 0.4 miles away.

FIG. 5B shows a smart navigation application device 102 such as a smartphone displaying the results of the same POI hour-based search as shown in FIG. 5A, but this time performed at 10:01 pm, in accordance with the principles of the present invention.

In particular, as shown in FIG. 5B, as compared with the display depicted in FIG. 5A, the WALMART shown to be 0.2 miles away is indicated with a suitable background color such as yellow as “closing within 1 hour”.

FIG. 5C shows a wireless navigation device such as a smartphone displaying the results of the same POI hour-based search as shown in FIGS. 5A and 5B, but this time performed at 11:15 pm, in accordance with the principles of the present invention.

In particular, as shown in FIG. 5C, as compared with the displays depicted in FIG. 5A and FIG. 5B, the WALMART POI shown in FIG. 5B is not presented by the smart navigation application system 102 on its display as it is closed at the time the search is performed. And at 11:15 pm (23:15), the LUCKY is indicated with appropriate background color as closing within 1 hour.

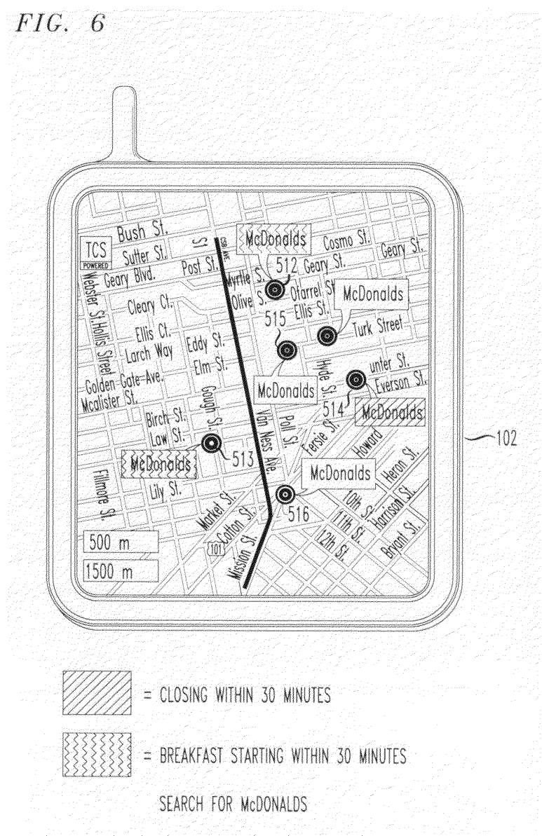

FIG. 6D shows a wireless navigation device such as a smartphone displaying the results of the same POI hour-based search as shown in FIGS. 5A-5C, but this time performed at 4:00 am, with a configuration radius of within 1 mile, in accordance with the principles of the present invention.

In particular, as shown in FIG. 5D, as compared with the displays depicted in FIGS. 5A, 5B and 5C, the WALMART POI shown in FIG. 5B, and the LUCKY POI and WALGREENS POI shown in FIG. 5C are not presented by the smart navigation application system 102 on its display as it is closed at the time the search is performed. Only the PHARMACY POI is open. Thus, even though four (4) POIs are within range and otherwise meet search criteria (e.g., within 1 mile), (LUCKY, WALMART, WALGREENS, PHARMACY) and thus only the PHARMACY POI is displayed.

FIG. 5E shows a wireless navigation device such as a smartphone displaying the results of the same POI hour-based search as shown in FIGS. 5A-5C, but this time performed at 4:00 am, and this time with a larger search radius configured of suitable pharmacies within 10 miles, in accordance with the principles of the present invention.

In particular, as shown in FIG. 5E, widening the radius of search for suitable POIs, though many more POIs meeting the criteria but for the hour-based information exist, only those that are open at 4 am (the time of the exemplary search) are displayed by the smart navigation application system 102.

FIG. 5F shows a smart navigation application system 102 such as a smartphone displaying the results of the same POI hour-based search as shown in FIGS. 5A-5C, but this time performed at 4:00 am, and this time configured to show POIs that will be opening at some point in the near future, e.g., within 1 hour, in accordance with the principles of the present invention.

In particular, as shown in FIG. 5F, based on hour-based information obtained from the POI hour-based database 101, though many more POIs are physically within the search criteria but for the time of day that the search is performed (or estimated TOA in other embodiments), only those POIs either currently open, or opening soon (e.g., within 1 hour) are displayed by the smart navigation application on the device 102. In the depicted display of the smart navigation application on the device 102, a POI called JOE'S will be opening within 1 hour.

FIG. 6 depicts the physical display of a smart navigation application system 101 such as a smartphone displaying the results of a POI hour-based search, configured to show POIs that will be closing at some point in the near future, e.g., within 30 minutes, as well as POIs within the search criteria that will have an hour-based feature occurring within the near future, e.g., breakfast starting within 30 minutes, in accordance with the principles of the present invention.

In particular, in a search for “McDONALDS” performed at a given time early in the morning as shown in FIG. 6, two POIs 512, 513 meeting the search criteria are indicated as having breakfast starting within 30 minutes, one POI 514 meeting the search criteria indicates that breakfast is ending within 30 minutes, and two other POIs 515, 516 meet the search criteria and do not have any hour-based activity occurring within the configured time frame (e.g., within the next 30 minutes).

In disclosed embodiments, filtering of matching POIs meeting criteria other than hour-based information is preferably performed by the mobile device navigation system 102 such that configurable time frames may be dynamically adjusted by the user to see more or fewer POIs at a given time.

The invention has particular application to mobile applications.

While the invention has been described with reference to the exemplary embodiments thereof, those skilled in the art will be able to make various modifications to the described embodiments of the invention without departing from the true spirit and scope of the invention.

What is claimed is:

1. A method of providing hour-based navigation to a physical navigation device, comprising:
identifying a plurality of physical points-of-interest (POI) based on navigation search criteria;
retrieving hour-based information relating to each of said plurality of physical POI;
displaying a time of estimated time of arrival to said retrieved hour-based information, together with hour-based information for each of said plurality of physical POI; and
filtering said plurality of physical POI to a sub-plurality of physical POI meeting a useable hour-based status.

2. The method of providing hour-based navigation to a physical navigation device according to claim 1, wherein:
said navigation device is comprised within a wireless phone.

3. The method of providing hour-based navigation to a physical navigation device according to claim 2, wherein:
said hour-based information indicates when said POI is open for business.

4. The method of providing hour-based navigation to a physical navigation device according to claim 2, wherein:
said hour-based information is an indication as to when breakfast is served.

5. The method of providing hour-based navigation to a physical navigation device according to claim 2, further comprising:
permitting configuration of a range of a vicinity within which said plurality of physical POI are located.

6. The method of providing hour-based navigation to a physical navigation device according to claim 5, wherein:
said range is 1 mile.

7. The method of providing hour-based navigation to a physical navigation device according to claim 5, wherein:
said range is 10 miles.

8. The method of providing hour-based navigation to a physical navigation device according to claim 1, further comprising:
obtaining traffic conditions affecting said estimated time of arrival (TOA); and
adjusting said displayed estimated time of arrival based on said obtained traffic conditions.

9. A method of providing hour-based navigation to a physical navigation device, comprising:
identifying a plurality of physical points-of-interest (POI) based on navigation search criteria;
retrieving hour-based information relating to each of said plurality of physical POI;
comparing an estimated time of arrival (TOA) to said retrieved hour-based information for each of said physical plurality of POI to determine an hour-based status of each of said plurality of physical POI when said physical navigation device would arrive at each of said physical plurality of POI; and
filtering said plurality of physical POI to a sub-plurality of physical POI suitably meeting an hour-based status.

10. The method of providing hour-based navigation to a physical navigation device according to claim 9, wherein:
said navigation device is comprised within a wireless navigation application.

11. The method of providing hour-based navigation to a physical navigation device according to claim 10, wherein:
said suitable hour-based status indicates that each of said sub-plurality of physical POI would all be open when arrived at.

12. The method of providing hour-based navigation to a physical navigation device according to claim 10, wherein:
said suitable hour-based status indicates that a relevant POI would be open for breakfast when arrived at.

13. The method of providing hour-based navigation to a physical navigation device according to claim 10, further comprising:
permitting configuration of a range of a vicinity within which said plurality of physical POI are located.

14. The method of providing hour-based navigation to a physical navigation device according to claim 13, wherein:
said range is 1 mile.

15. The method of providing hour-based navigation to a physical navigation device according to claim 13, wherein:
said range is 10 miles.

16. The method of providing hour-based navigation to a physical navigation device according to claim 9, further comprising:
obtaining traffic conditions affecting said estimated time of arrival (TOA); and
adjusting said displayed estimated time of arrival based on said obtained traffic conditions.

17. The method of providing hour-based navigation to a physical navigation device according to claim 9, further comprising:
obtaining weather conditions affecting said estimated time of arrival (TOA); and
adjusting said displayed estimated time of arrival based on said obtained weather conditions.
